(19) United States
(12) Patent Application Publication
(10) Pub. No.: US 2022/0071276 A1
(43) Pub. Date: Mar. 10, 2022

(54) AEROSOL-GENERATING ARTICLE HAVING ROD COMPRISING TOBACCO MATERIAL WITH FORMED FLUID PASSAGEWAYS

(71) Applicant: Philip Morris Products S.A., Neuchatel (CH)

(72) Inventors: Gaetan COUDERC, Neuchatel (CH); Roelof Cornelis DE BORST, Neuchatel (CH); Celine GAMBS, Neuchatel (CH); Marine JARRIAULT, Neuchatel (CH); Celine LESUFFLEUR, Neuchatel (CH); Mirko MINZONI, Neuchatel (CH)

(73) Assignee: Philip Morris Products S.A., Neuchatel (CH)

(21) Appl. No.: 17/419,468

(22) PCT Filed: Dec. 30, 2019
(86) PCT No.: PCT/EP2019/087149

§ 371 Date: Jun. 29, 2021

(30) Foreign Application Priority Data
Dec. 31, 2018 (EP) 18216001.0

(51) Int. Cl. A24D 1/20; A24F 40/465; A24F 40/20; A24C 5/01

(52) U.S. Cl. CPC A24D 1/20; A24C 5/01; A24F 40/20; A24F 40/465

(57) ABSTRACT

An aerosol-generating article for producing an inhalable aerosol upon heating is provided, the aerosol-generating article including: a rod of aerosol-generating substrate, the rod including a sheet of homogenised plant material, the homogenised plant material being arranged longitudinally between an upstream end of the rod and a downstream end of the rod; and a wrapper circumscribing the homogenised plant material, the sheet of homogenised plant material including a plurality of formed fluid passageways extending through a thickness of the sheet and configured to establish a fluid communication between opposite sides of the sheet. A method of making a rod for an aerosol-generating substrate in an aerosol-generating article, a rod for an aerosol-generating substrate in an aerosol-generating article, and an aerosol-generating system, are also provided.

The present invention relates to an aerosol-generating article for producing an inhalable aerosol upon heating, the aerosol-generating article comprising a rod of aerosol-generating substrate formed from a sheet of homogenised tobacco material or tobacco lamina material, and to a method for the production of such a rod of aerosol-generating substrate.

Aerosol-generating articles in which an aerosol-generating substrate, such as a tobacco-containing substrate, is heated rather than combusted, are known in the art. One aim of such heated smoking articles is to reduce known harmful smoke constituents of the type produced by the combustion of tobacco in conventional cigarettes.

Typically in such heated smoking articles, an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form aerosol droplets.

A number of prior art documents disclose aerosol-generating devices for consuming or smoking heated aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article.

An electrically heated aerosol-generating device typically comprises a heating chamber adapted to removably receive the aerosol-generating substrate of an article that can be inserted by a user, and removed by the user after use. In such devices, the aerosol generating substrate may receive heat from a surrounding surface of the heating chamber. As an alternative, the aerosol-generating device may comprise an internal heating element, such as a heating blade or pin extending into the heating chamber and adapted to penetrate the aerosol-generating substrate of the article as the article is received within the chamber. Aerosol-generating articles of this type are described in the prior art, for example, in EP-A-0 822 670.

In an alternative arrangement, the aerosol-generating article may comprise a heating element provided in the form of a susceptor embedded in the aerosol-generating substrate. Heating of the aerosol-generating substrate can therefore be achieved in a contactless manner, for example by induction-heating. To this purpose, the aerosol-generating device may comprise an induction source configured to produce an alternating electromagnetic field that induces a heat generating eddy current in the susceptor material.

Substrates for heated aerosol-generating articles have, in the past, typically been produced using randomly oriented shreds, strands, or strips of tobacco material.

As an alternative, it is known from WO-A-2012/164009 to provide rods for heated aerosol-generating articles that are formed from gathered sheets of tobacco material. The rods disclosed in WO-A-2012/164009 have a longitudinal porosity that allows air to be drawn through the rods. Effectively, folds in the gathered sheets of tobacco material define longitudinal channels through the rod.

It would be desirable to provide an aerosol-generating article for producing an aerosol upon heating, the article comprising a rod of aerosol-generating substrate that optimises the heat transfer from the heater (particularly for internal heating sources such as a susceptor-type heater, a pin heater, or a blade heater) through the rod of aerosol-generating substrate. Further, it would be desirable to provide one such aerosol-generating article that provides an improved aerosol generation and delivery. In general, it would be desirable if one such improved aerosol-generating article could be manufactured efficiently and at high speed.

According to a first aspect of the present invention, there is provided an aerosol-generating article for producing an aerosol upon heating, the aerosol-generating article comprising a rod of aerosol-generating substrate, wherein the rod of aerosol-generating substrate comprises one or more sheets of homogenised plant material. The one or more sheets of homogenised plant material is arranged extending longitudinally between an upstream end of the rod and a downstream end of the rod. Further, the aerosol-generating article comprises a wrapper circumscribing the homogenised plant material. The one or more sheets of homogenised plant material comprises a plurality of formed fluid passageways extending through a thickness of the one or more sheets of homogenised plant material and adapted to establish a fluid communication between opposite sides of the one or more sheets of homogenized plant material. Preferably, the homogenised plant material is a homogenised tobacco material. According to some embodiments of the first aspect of the invention, the aerosol generating article further comprises strips of plant lamina material, such as tobacco lamina material. The strips of plant lamina material may comprise formed fluid passageways therethrough.

According to a second aspect of the present invention, there is provided a method of making a rod for use as an aerosol-generating substrate in an aerosol-generating article, the method comprising the steps of: providing one or more sheets of homogenised plant material; forming a plurality of fluid passageways in the sheet of homogenised plant material, the formed fluid passageways extending through a thickness of the sheet of homogenised plant material; circumscribing the homogenous plant material with a wrapper to form a continuous rod, the homogenised plant material being arranged within the wrapper to extend longitudinally between an upstream end of the rod and a downstream end of the rod, the plurality of formed fluid passageways establishing a fluid communication between opposite sides of the sheet material; and severing the continuous rod into a plurality of discrete rods. Preferably, the homogenised plant material is a homogenised tobacco material. According to some embodiments of the first aspect of the invention, the aerosol generating article further comprises strips of plant lamina material, such as tobacco lamina material. The strips of plant lamina material may comprise formed fluid passageways therethrough.

According to a third aspect of the present invention, there is provided a rod for use as an aerosol-generating substrate in an aerosol-generating article, the rod comprising one or more sheets of homogenised plant material, the homogenised plant material being arranged within the rod to extend longitudinally between an upstream end of the rod and a downstream end of the rod. The rod further comprises a wrapper circumscribing the homogenised plant material. The sheet of homogenised plant material comprises a plurality of formed fluid passageways extending through a thickness of the sheet and adapted to establish a fluid communication between the two sides of the material. Preferably, the homogenised plant material is a homogenised tobacco material. According to some embodiments of the first aspect of the invention, the aerosol generating article further comprises strips of plant lamina material, such as tobacco lamina material. The strips of plant lamina material may comprise formed fluid passageways therethrough.

According to a fourth aspect of the present invention, there is provided an aerosol-generating system comprising an aerosol-generating article of the type described above, the aerosol-generating article further comprising a heating element provided as a susceptor embedded within the rod of aerosol-generating substrate. Further, the aerosol-generating system comprises an aerosol-generating device comprising a cavity configured to receive the aerosol-generating article and an induction source heater configured to produce an alternating electromagnetic field adapted to induce a heat generating eddy current in a susceptor material of the susceptor.

According to a fifth aspect of the present invention, there is provided an apparatus for manufacturing an aerosol-generating substrate for use in an aerosol-generating article, the apparatus comprising: a conveyor for advancing an aerosol-generating material in the form of a sheet in a predetermined plane along a first direction; and a perforating member comprising a passageway-forming means adapted to form an airflow passageway at a predetermined location on the aerosol-generating material being advanced, the airflow passageway extending through a thickness of the aerosol-generating material. It shall be appreciated that any features described with reference to one aspect of the present invention are equally applicable to any other aspect of the invention.

As used herein, the term “aerosol-generating article” is used to denote an aerosol-generating article for producing an inhalable aerosol, the article comprising an aerosol-generating substrate that is intended to be heated rather than combusted in order to release volatile compounds that can form an aerosol.

As used herein, the term “aerosol-generating substrate” refers to a substrate capable of releasing upon heating volatile compounds, which can form an aerosol. The aerosol generated from aerosol-generating substrates of aerosol-generating articles described herein may be visible or invisible and may include vapours (for example, fine particles of substances, which are in a gaseous state, that are ordinarily liquid or solid at room temperature) as well as gases and liquid droplets of condensed vapours.

As used herein, the term “rod” refers to a generally cylindrical element of substantially circular, oval or elliptical cross-section.

The term “sheet” is used herein to refer to a laminar element having a width and length substantially greater than the thickness thereof.

As used herein, the term “homogenised plant material” encompasses any plant material formed by the agglomeration of particles of plant material. Sheets or webs of homogenised plant material are formed by agglomerating particulate plant obtained by grinding or otherwise powdering of one or both of plant leaf lamina and plant leaf stems. In addition, homogenised plant material may comprise a minor quantity of one or more of plant dust, plant fines, and other particulate plant by-products formed during the treating, handling and shipping of plant material. In preferred embodiments of the present invention, the homogenised plant material is homogenised tobacco material.

Preferably, the aerosol-generating substrate comprises cut-filler. In this document, “cut-filler” is used to refer to a blend of shredded plant material, in particular leaf lamina, processed stems and ribs, homogenized plant material, like for example made into sheet form using casting or papermaking processes. The cut filler may also comprise other after-cut, filler tobacco or casing. According to preferred embodiments of the invention, the cut-filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. However, the invention is equally applicable to other plant material that has the ability to release substances upon the application of heat that can subsequently form an aerosol.

Advantageously, a more natural taste and appearance of the aerosol-generating article can be achieved by using natural plant material lamina. The term “lamina” refers to the part of a plant leaf blade, that is the broad, substantially flat part of a leaf, that is left when the stem is removed.

Preferably, the tobacco plant material comprises lamina of one or more of bright tobacco lamina, dark tobacco, aromatic tobacco and filler tobacco. Bright tobaccos are tobaccos with a generally large, light coloured leaves. Throughout the specification, the term “bright tobacco” is used for tobaccos that have been flue cured. Examples of bright tobaccos are Chinese Flue-Cured, Flue-Cured Brazil, US Flue-Cured such as Virginia tobacco, Indian Flue-Cured, Flue-Cured from Tanzania or other African Flue Cured. Bright tobacco is characterised by a high sugar to nitrogen ratio. From a sensorial perspective, bright tobacco is a tobacco type which, after curing, is associated with a spicy and lively sensation. Bright tobaccos are tobaccos with a content of reducing sugars of between about 2.5 percent and about 20 percent of dry weight base of the leaf and a total ammonia content of less than about 0.12 percent of dry weight base of the leaf. Reducing sugars comprise for example glucose or fructose. Total ammonia comprises for example ammonia and ammonia salts. Dark tobaccos are tobaccos with a generally large, dark coloured leaves. Throughout the specification, the term “dark tobacco” is used for tobaccos that have been air cured. Additionally, dark tobaccos may be fermented. Tobaccos that are used mainly for chewing, snuff, cigar, and pipe blends are also included in this category. Typically, these dark tobaccos are air cured and possibly fermented. From a sensorial perspective, dark tobacco is a tobacco type which, after curing, is associated with a smoky, dark cigar type sensation. Dark tobacco is characterised by a low sugar to nitrogen ratio. Examples of dark tobacco are Burley Malawi or other African Burley, Dark Cured Brazil Galpao, Sun Cured or Air Cured Indonesian Kasturi. Dark tobaccos are tobaccos with a content of reducing sugars of less than about 5 percent of dry weight base of the leaf and a total ammonia content of up to about 0.5 percent of dry weight base of the leaf. Aromatic tobaccos are tobaccos that often have small, light coloured leaves. Throughout the specification, the term “aromatic tobacco” is used for other tobaccos that have a high aromatic content, for example of essential oils. From a sensorial perspective, aromatic tobacco is a tobacco type which, after curing, is associated with spicy and aromatic sensation. Examples of aromatic tobaccos are Greek Oriental, Oriental Turkey, semi-oriental tobacco but also Fire Cured, US Burley, such as Perique, Rustica, US Burley or Maryland. Filler tobacco is not a specific tobacco type, but it includes tobacco types which are mostly used to complement the other tobacco types used in the blend and do not bring a specific characteristic aroma direction to the final product. Examples for filler tobaccos are stems, midrib or stalks of other tobacco types. A specific example may be flue cured stems of Flue Cure Brazil lower stalk.

However, using a high amount of natural leaf in the cut filler requires high amounts of aerosol-former, in particular at low temperatures. In embodiments including a high amount of natural leaf in combination with high amounts of aerosol-former the aerosol-generating substrate is preferably circumscribed by a special wrapper that prevents the appearance of stains caused by the high aerosol-former content. In particular, a heat-conducting material, like for example metal, prevents the appearance of stains very well. In that respect, it has been found that staining can be conveniently prevented irrespective of the orientation of the heat conducting layer in respect to the aerosol-forming substrate, that is, whether the heat-conducting layer faces towards the aerosol-forming substrate or whether the heat-conducting layer faces away from the aerosol-forming substrate.

In the context of the present invention, the term “homogenised tobacco material” also encompasses sheets or webs of a non-tobacco sorbent substrate comprising a tobacco-derived substance, such as nicotine. For example, this encompasses a sheet of a non-tobacco sorbent material onto which nicotine in the form of a nicotine salt is absorbed or otherwise applied, such as by coating. The non-tobacco sorbent substrate may be a sheet of cellulosic-based material, such as a sheet of paper. As an alternative, the non-tobacco sorbent substrate may be a sheet formed from non-tobacco plant material, for example by agglomerating particulate plant material obtained by grinding or otherwise powdering plant leaf material or plant root material.

As used herein, the term “longitudinal” refers to the direction corresponding to the main longitudinal axis of the aerosol-generating article, which extends between the upstream and downstream ends of the aerosol-generating article. The term “transverse” refers to the direction that is perpendicular to the longitudinal axis.

As used herein, the terms “upstream” and “downstream” describe the relative positions of elements, or portions of elements, of the aerosol-generating article in relation to the direction in which a user draws on the aerosol-generating article during use. During use, air is drawn through the aerosol-generating article in the longitudinal direction.

Any reference to the “cross-section” of the aerosol-generating article or a component of the aerosol-generating article refers to the transverse cross-section unless stated otherwise. As used herein, the term “length” refers to the dimension of a component in the longitudinal direction and the term “width” refers to the dimension of a component in the transverse direction. The term “maximum width” refers to the maximum cross-sectional dimension of a component. For example, in the case of a rod having a circular cross-section, the maximum width correspond to the diameter of the circle. When used in relation to the sheets of homogenised tobacco material, the term “width” should be considered to refer to the width of the sheet when it is laid flat.

As used herein, the term “gathered” denotes that the sheet of homogenised plant material, such as a sheet of homogenised tobacco material, is convoluted, folded, or otherwise compressed or constricted substantially transversely to a cylindrical axis of the rod. The gathered sheet of homogenised plant material preferably extends along substantially the entire length of the rod and across substantially the entire transverse cross-sectional area of the rod.

As used herein, the term “crimped” denotes a sheet or web having a plurality of substantially parallel ridges or corrugations. Preferably, a crimped sheet of homogenised plant material, such as a sheet of homogenised tobacco material, has a plurality of ridges or corrugations substantially parallel to the cylindrical axis of the rod according to the invention. This advantageously facilitates gathering of the crimped sheet of homogenised plant material to form the rod. The sheet may be crimped by passing it through a set of crimping rollers. The degree to which the sheet is crimped is denoted by a crimping depth. Variation in the crimping depth may affect the manner in which the sheet is gathered, and may therefore influence the size of the channels through the rod and the cross-sectional porosity distribution. Thus, the crimping depth or amplitude is a parameter that may be varied to produce a desired cross-sectional porosity distribution value in a rod.

As used herein, the term “stacked” refers to the arrangement of two or more sheets of homogenised plant material one on top of each other. In the present invention, “stacked” sheets are preferably arranged one on top of each other with spacing between adjacent sheets. However, the term “stacked” encompasses arrangements of sheets in which adjacent sheets are partially in contact with each other. The term “stacked” is used herein irrespective of the orientation of the stacked sheets.

As described briefly above, an aerosol-generating article in accordance with the present invention incorporates a rod formed from a sheet of homogenised plant material and which may optionally comprise plant lamina material. By way of example, the rod may comprise one or more gathered or stacked sheets of homogenised tobacco material. In other embodiments, the rod may comprise a plurality of stacked sheets of homogenised tobacco material, as described in detail in co-pending application PCT/EP2018/071483.

In contrast to existing aerosol-generating articles, in articles in accordance with the invention the sheet of homogenised plant material or the plant lamina material from which the rod is formed comprises a predetermined airflow arrangement. This comprises a plurality of formed fluid passageways extending through a thickness of the sheet or through a thickness of the lamina material, the formed fluid passageways being adapted to establish a fluid communication between opposite sides of the sheet of homogenised plant material or by the plant lamina material.

The term “predetermined airflow arrangement” is used herein to stress that, in articles and rods in accordance with the invention, the plurality of formed fluid passageways effectively provide conduits at predetermined locations across the surface of the homogenised plant material or the plant lamina material, such that fluid communication is established between opposite sides of the homogenised plant material or the plant lamina material in a controlled manner. When referring to a sheet of homogenised plant material, the term “opposite sides” denotes sides of the homogenised plant material that define surfaces substantially parallel to one another, due to the sheet-making process resulting into a substantially flat sheet. It will be appreciated that, when referring to a portion of plant lamina material, the term “opposite sides” may denote sides of the plant lamina material that are not nearly as close to defining outer surfaces substantially parallel to one another.

In contrast to passageways that may naturally or accidentally occur in the plant material, the formed fluid passageways have the advantage that fluid communication between opposite sides of the homogenised plant material or the plant lamina material is established at predetermined locations, and by conduits having a predetermined cross-sectional surface area. This has the advantage that airflow may be facilitated through the thickness of the homogenised plant material or the plant lamina material in a controlled and reliable manner, the number and size of the conduits being adjustable to regulate the entity and distribution of the airflow across the plant material. Further, any type of predetermined airflow arrangement (for example, in terms of pattern, conduit size, etc.) is easy to reproduce in different plant materials, which advantageously enhances repeatability and consistency.

The inventors have found that the provision of formed fluid passageways extending through homogenised plant material or plant lamina material in any suitable geometric arrangement of the plant material within the rod enables a better dispersion of heat throughout the plant material during use. This is particularly the case where the rod comprises one or more sheets of homogenised tobacco material, optionally in combination with tobacco lamina material. In those embodiments, such improved dispersion of heat throughout the tobacco material improves the aerosol former and nicotine delivery, and the effect is particularly advantageous where heating is achieved by means of a susceptor heating element embedded in the rod or a blade heater or a pin heater.

Without wishing to be bound by theory, it is understood that the provision of formed fluid passageways into the sheet of aerosol-generating substrate impacts heat transfer both by enabling airflow in a direction transversal to the surface of the sheet as well as by increasing the surface area available for heat exchange and evaporation of vaporisable species. In addition, during manufacture, in the step of forming the airflow passageways through the sheet of aerosol-generating substrate, material bridges may be established between adjacent layers of aerosol-generating substrate (for example, portions of aerosol-generating material not entirely detached, but folded away from their original flat state and extending between adjacent sheet portions).

By adjusting and varying the size, number and distribution of the formed fluid passageways it is advantageously possible to adjust the heat dispersion across the entire aerosol-generating substrate.

Advantageously, rods in accordance with the present invention can be made in a continuous process which can be efficiently carried out at high speed and can be conveniently incorporated into existing production lines for the manufacture of heated smoking articles, without requiring any major modification of existing apparatus.

Sheets for forming the aerosol-generating substrate of articles according to the invention may be formed of a homogenous tobacco material, which preferably comprises particulate tobacco obtained by grinding or otherwise comminuting tobacco leaf lamina. In a same article, one or more sheets can be used. The sheets may all have substantially the same composition as each other. Alternatively, the sheets may include sheets of at least two different compositions.

Sheets of homogenised tobacco material for use in the invention may have a tobacco content of at least about 40 percent by weight on a dry weight basis, more preferably of at least about 50 percent by weight on a dry weight basis and most preferably at least about 70 percent by weight on a dry weight basis.

Sheets of homogenised tobacco material for use in the aerosol-generating substrate may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material for use in the aerosol-generating substrate may comprise other additives including, but not limited to, tobacco and non-tobacco fibres, aerosol-formers, humectants, plasticisers, flavourants, fillers, aqueous and non-aqueous solvents and combinations thereof.

Suitable extrinsic binders for inclusion in sheets of homogenised tobacco material for use in the aerosol-generating substrate are known in the art and include, but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and pectins; and combinations thereof.

Suitable non-tobacco fibres for inclusion in sheets of homogenised tobacco material for use in the aerosol-generating substrate are known in the art and include, but are not limited to: cellulose fibres; soft-wood fibres; hard-wood fibres; jute fibres and combinations thereof. Prior to inclusion in sheets of homogenised tobacco material for use in the aerosol-generating substrate, non-tobacco fibres may be treated by suitable processes known in the art including, but not limited to: mechanical pulping; refining; chemical pulping; bleaching; sulphate pulping; and combinations thereof.

Preferably, the sheets of homogenised tobacco material comprise an aerosol former.

As used herein, the term “aerosol former” describes any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

Preferred aerosol formers are polyhydric alcohols or mixtures thereof, such as propylene glycol, triethylene glycol, 1,3-butanediol and, most preferred, glycerine.

The sheets of homogenised tobacco material may comprise a single aerosol former. Alternatively, the sheets of homogenised tobacco material may comprise a combination of two or more aerosol formers.

Preferably, the sheets of homogenised tobacco material have an aerosol former content of greater than 5 percent on a dry weight basis.

The sheets of homogenised tobacco material may have an aerosol former content of between approximately 5 percent and approximately 30 percent on a dry weight basis.

In a preferred embodiment, the sheets of homogenised tobacco material have an aerosol former content of approximately 20 percent on a dry weight basis.

Sheets of homogenised tobacco for use in the aerosol-generating article of the present invention may be made by methods known in the art, for example the methods disclosed in WO-A-2012/164009 A2.

The sheet of homogenised tobacco material may be a smooth sheet. Alternatively, the sheet may be treated to facilitate the gathering of the sheet. For example, the sheet may be grooved, creased, folded, textured, embossed, or otherwise treated to provide lines of weakness to facilitate gathering. A preferred treatment for the continuous sheet is crimping.

Alternatively or in addition to the provision of texture on the surface of at least one of the plurality of sheets, an additive may be applied to at least a part of a surface of at least one of the plurality of sheets. The additive may be a solid additive, a liquid additive, or a combination of a solid additive and a liquid additive. Suitable solid and liquid additives for use in the invention are known in the art and include, but are not limited to: flavourants, such as for example menthol; adsorbents, such as for example activated carbon; and botanical additives.

In a preferred embodiment, sheets of homogenised tobacco material for use in the aerosol-generating article are formed from a slurry comprising particulate tobacco, guar gum, cellulose fibres and glycerine by a casting process.

Preferably, the sheet of homogenised plant material or the plant lamina material comprises at least about 20 formed fluid passageways per square centimetre. More preferably, the sheet of homogenised plant material or the plant lamina material comprises at least about 25 formed fluid passageways per square centimetre. Even more preferably, the sheet of homogenised plant material or the plant lamina material comprises at least about 30 formed fluid passageways per square centimetre.

In addition, or as an alternative, the sheet of homogenised plant material or the plant lamina material preferably comprises less than about 60 formed fluid passageways per square centimetre. More preferably, the sheet of homogenised plant material or the plant lamina material comprises less than about 50 formed fluid passageways per square centimetre. Even more preferably, the sheet of homogenised plant material or the plant lamina material comprises less than about 40 formed fluid passageways per square centimetre.

In preferred embodiments, the sheet of homogenised plant material or the plant lamina material preferably comprises from about 20 formed fluid passageways per square centimetre to about 60 formed fluid passageways per square centimetre, more preferably from about 25 formed fluid passageways per square centimetre to about 50 formed fluid passageways per square centimetre. In particularly preferred embodiments, the sheet of homogenised plant material or the plant lamina material comprises from about 25 formed fluid passageways per square centimetre to about 40 formed fluid passageways per square centimetre.

The inventors have found that in aerosol-generating articles wherein the rod is formed from a sheet of homogenised plant material or plant lamina material having one such formed fluid passageway density, that is, wherein the sheet of homogenised plant material or the plant lamina material has a number of formed fluid passageways per unit of surface area falling within the ranges described above, it is advantageously possible to achieve an improved heat diffusion during use. This has been found to favour an increased delivery of aerosol to the user.

Preferably, an average equivalent diameter of the formed fluid passageways is at least about 100 micrometres. The term “equivalent diameter” is used to denote the diameter of a circle having the same cross-sectional surface area of a cross-section of a formed fluid passageway. More preferably, an average equivalent diameter of the formed fluid passageways is at least about 125 micrometres. Even more preferably, an average equivalent diameter of the formed fluid passageways is at least about 250 micrometres.

In addition, or as an alternative, an average equivalent diameter of the formed fluid passageways is preferably less than about 750 micrometres. More preferably, an average equivalent diameter of the formed fluid passageways is preferably less than about 625 micrometres. Even more preferably, an average equivalent diameter of the formed fluid passageways is preferably less than about 500 micrometres.

In preferred embodiments, an average equivalent diameter of the formed fluid passageways is from about 100 micrometres to about 750 micrometres, more preferably from about 125 micrometres to about 625 micrometres. It has been found that with formed fluid passageways having a cross-sectional surface area falling within these ranges, it is easy to obtain an increase in heat diffusion within the rod during use and, as a consequence, an improved aerosol delivery. Such ranges sufficiently preserve the tensile strength and structural properties of the sheet or plant lamina, particularly in the case of sheets of homogenised tobacco material and of tobacco lamina material. This is particularly advantageous in view of critical steps in the manufacturing process, such as the gathering or crimping of the sheet of homogenised plant material, particularly in the case of a homogenised tobacco material.

The formed fluid passageways may be of any suitable cross-sectional shape, including but not limited to rectangular, cruciform, oval, circular.

Preferably, a cross-section of the formed fluid passageways is substantially circular or oval. Where the cross-section of the formed fluid passageways is substantially circular, the equivalent diameter substantially coincides with the actual diameter of the cross-section of the formed fluid passageways.

The cross-section shape of the formed fluid passageways will generally be constant along the thickness of the sheet of homogenised plant material. In some embodiments, the cross-sectional area of each formed fluid passageway may vary along the thickness of the sheet of homogenised plant material, for example by tapering along the thickness of the sheet of homogenised plant material. Thus, in some embodiments, a formed fluid passageway may be frustoconical or substantially conical.

Preferably, a cumulative surface area of the formed fluid passageways in the sheet of homogenised plant material or in the plant lamina material represents at least about 0.1 percent of a surface area of the sheet of homogenised plant material or in the plant lamina material. More preferably, a cumulative surface area of the formed fluid passageways in the sheet of homogenised plant material or in the plant lamina material represents at least about 0.2 percent of a surface area of the sheet of homogenised plant material or in the plant lamina material. Even more preferably, a cumulative surface area of the formed fluid passageways in the sheet of homogenised plant material or in the plant lamina material represents at least about 0.4 percent of a surface area of the sheet of homogenised plant material or in the plant lamina material.

In addition, or as an alternative, a cumulative surface area of the formed fluid passageways in the sheet of homogenised plant material or in the plant lamina material preferably represents less than about 45 percent of a surface area of the sheet of homogenised plant material or in the plant lamina material. More preferably, a cumulative surface area of the formed fluid passageways in the sheet of homogenised plant material or in the plant lamina material represents less than about 25 percent of a surface area of the sheet of homogenised plant material or in the plant lamina material. Even more preferably, a cumulative surface area of the formed fluid passageways in the sheet of homogenised plant material or in the plant lamina material represents less than about 10 percent of a surface area of the sheet of homogenised plant material or in the plant lamina material.

In some particularly preferred embodiments, a cumulative surface area of the formed fluid passageways in the sheet of homogenised plant material or in the plant lamina material represents less than about 5 percent of a surface area of the sheet of homogenised plant material or in the plant lamina material, preferably less than about 2 percent of a surface area of the sheet of homogenised plant material or in the plant lamina material, even more preferably less than 1 percent of a surface area of the sheet of homogenised plant material or in the plant lamina material.

In some embodiment, the formed fluid passageways are provided in a repeating pattern. Preferably, the repeating pattern comprises a plurality of spaced apart rows of formed fluid passageways. This may advantageously help achieve a particularly homogeneous heat diffusion and, as a consequence, a more desirable temperature profile along the length and in particular across the cross section of the rod during use.

In preferred embodiments, a linear distance between adjacent formed fluid passageways in a row of formed fluid passageways is at least about 1 millimetre. More preferably, a linear distance between adjacent formed fluid passageways in a row of formed fluid passageways is at least about 1.5 millimetres. Even more preferably, a linear distance between adjacent formed fluid passageways in a row of formed fluid passageways is at least about 2 millimetres.

In addition, or as an alternative, a linear distance between adjacent formed fluid passageways in a row of formed fluid passageways is preferably less than about 7 millimetres. More preferably, a linear distance between adjacent formed fluid passageways in a row of formed fluid passageways is less than about 5 millimetres. Even more preferably, a linear distance between adjacent formed fluid passageways in a row of formed fluid passageways is less than about 3 millimetres.

Preferably, a thickness of the sheet of homogenised plant material or of the plant lamina material is at least about 25 micrometres. More preferably, a thickness of the sheet of homogenised plant material or of the plant lamina material is at least about 50 micrometres. These values are particularly preferable for sheets of homogenised tobacco material or for tobacco lamina material. Even more preferably, a thickness of the sheet or of the lamina is at least about 65 micrometres. In particularly preferred embodiments, a thickness of the sheet or of the lamina is at least about 80 micrometres.

In addition, or as an alternative, a thickness of the sheet or of the lamina is preferably less than about 500 micrometres. More preferably, a thickness of the sheet or of the lamina is less than about 300 micrometres. Even more preferably, a thickness of the sheet or of the lamina is less than about 250 micrometres. In particularly preferred embodiments, a thickness of the sheet or of the lamina is less than about 200 micrometres.

In preferred embodiments, a thickness of the sheet or of the lamina is preferably from about 25 micrometres to about 500 micrometres, more preferably from about 50 micrometres to about 300 micrometres.

In preferred embodiments, the sheet of homogenised plant material is crimped. In particularly preferred embodiments, the sheet of homogenised plant material is a crimped sheet of homogenised tobacco material.

As mentioned before, the term “crimped” denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article.

In preferred embodiments, the formed fluid passageways are formed in a non-crimped portion of the sheet. In other words, the formed fluid passageways are formed through portions of the sheet between pairs of ridges or corrugations formed by crimping the sheet. This is advantageous in that the formed fluid passageways do not further increase the fragility of the sheet at the ridges or corrugations.

The rod of aerosol-generating substrate preferably has an external diameter that is approximately equal to the external diameter of the aerosol-generating article.

Preferably, the rod of aerosol-generating substrate has an external diameter of at least 5 millimetres. The rod of aerosol-generating substrate may have an external diameter of between about 5 millimetres and about 12 millimetres, for example of between about 5 millimetres and about 10 millimetres or of between about 6 millimetres and about 8 millimetres. In a preferred embodiment, the rod of aerosol-generating substrate has an external diameter of 7.2 millimetres, to within 10 percent.

The rod of aerosol-generating substrate may have a length of between about 7 millimetres and about 15 mm. In one embodiment, the rod of aerosol-generating substrate may have a length of about 10 millimetres. In a preferred embodiment, the rod of aerosol-generating substrate has a length of about 12 millimetres.

Preferably, the rod of aerosol-generating substrate has a substantially uniform cross-section along the length of the rod. Particularly preferably, the rod of aerosol-generating substrate has a substantially circular cross-section.

As described above, the tobacco material from which the rod of aerosol-generating substrate is formed is circumscribed by a wrapper in the rod. The wrapper may be formed of a porous or non-porous sheet material. The wrapper may be formed of any suitable material or combination of materials. Preferably, the wrapper is a paper wrapper.

The aerosol-generating articles according to the invention preferably comprise one or more elements in addition to the rod of aerosol-generating substrate, wherein the rod and the one or more elements are assembled within a cigarette paper. For example, aerosol-generating articles according to the invention may further comprise at least one of: a mouthpiece, such as a mouthpiece comprising a segment of filtration material like a plug of cellulose acetate tow; an aerosol-cooling element; and a support element, such as a hollow acetate tube.

For example, in one preferred embodiment, an aerosol-generating article comprises, in linear sequential arrangement, a rod of aerosol-generating substrate as described above, a support element located immediately downstream of the aerosol-generating substrate, an aerosol-cooling element located downstream of the support element, and an outer wrapper circumscribing the rod, the support element and the aerosol-cooling element.

The resistance to draw (RTD) of the rod of aerosol-generating substrate is preferably between about 50 mm WG and about 80 mm WG. Preferably, the RTD of the rod of aerosol-generating substrate is between about 5 mm WG and about 8 mm WG per millimetre length of the rod. As used herein, resistance to draw is expressed with the units of pressure ‘mm WG’ or ‘mm of water gauge’ and is measured in accordance with ISO 6565:2002.

The RTD of the rod may be adapted by varying the arrangement of the plant material or characteristics thereof, such as for example, the thickness of the sheet or lamina material, or both.

The rods of aerosol-generating substrate for use in aerosol-generating articles according to the invention, described in detail above, may be produced using a method according to the second aspect of the invention, as defined above. In a first step of the method according to the invention, a sheet of homogenous plant material is provided. In a second step, a fluid passageways are formed in the sheet of homogenised plant material, wherein the formed fluid passageways extend through a thickness of the sheet of homogenised plant material.

In a third step, the homogenised plant material is circumscribed by a wrapper to form a continuous rod. The homogenised plant material is arranged within the wrapper extending longitudinally between an upstream end of the rod and a downstream end of the rod, wherein the plurality of formed fluid passageways of the predetermined airflow arrangement establish a fluid communication between opposite sides of the sheet material. In a fourth step of the method, the continuous rod is severed into a plurality of discrete rods.

The steps of circumscribing the plurality of sheets with the wrapper to form a continuous rod and severing the continuous rod to form discrete rods may be carried out using existing apparatus and techniques, which would be known to the skilled person.

The formed fluid passageways may be formed in the sheet of homogenised plant material by means of perforating equipment such as apparatus for the perforation of paper commonly used in the packaging field. This facilitates the formation of formed fluid passageways arranged regularly and having consistent cross-section shapes. In an embodiment, the formed fluid passageways may be formed in the sheet of homogenised tobacco material (for example, cast leaf) by an electro-perforating process, which may be followed by a step of calendering and micro-engraving for forming grooves with a depth of about 2 micrometres in the homogenised tobacco material.

An aerosol-generating substrate for use in the manufacture of a rod of aerosol-generating substrate of an article in accordance with the present invention may be manufactured by means of an apparatus comprising: a conveyor for advancing an aerosol-generating material in the form of a sheet in a predetermined plane along a first direction; and a perforating member comprising a passageway-forming means adapted to form an airflow passageway at a predetermined location on the aerosol-generating material being advanced, the airflow passageway extending through a thickness of the aerosol-generating material.

In some embodiments, the passageway-forming means are configured to directly (that is, mechanically) cooperate with the advancing aerosol-generating material to form the airflow passageways. The perforating member may, to this purpose, comprise a plurality of pins extending outwards from a surface of the perforating member. By way of example, the perforating member may comprise a plurality of pins provided on a substantially cylindrical surface of the perforating member and be configured to rotate about an axis substantially perpendicular to the first direction, the plurality of pins cooperating with the aerosol-generating material to form a corresponding plurality of formed airflow passageways extending through a thickness of the aerosol-generating material while the aerosol-generating material is advanced. By varying the size (length, cross-section) of the pins, or by varying the density of the pins (that is, the number of pins per square centimetre of surface area of the cylindrical surface of the perforating member) or both, it is advantageously possible to adjust the number, density and size of the plurality of formed airflow passageways in the sheet of aerosol-generating substrate. By way of example, rollers may be used that have various combinations of the parameters described above in order to manufacture, starting from a same aerosol-generating material in the form of a sheet, a variety of aerosol-generating substrates having formed airflow passageways having different geometric parameters.

As an alternative, the perforating member may comprise a plurality of pins that are moved linearly to cooperate with the advancing aerosol-generating material.

In other embodiments, the passageway-forming means may be configured to form the airflow passageways without a direct interaction with the aerosol-generating material, such as via the generation of an electromagnetic radiation (e.g. laser perforation).

The invention will now be further described with reference to the following Examples and figures, in which:

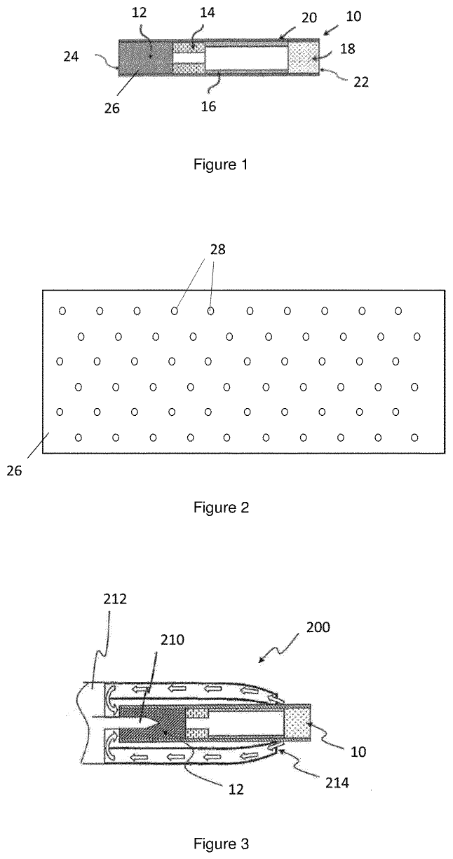

FIG. 1 shows a schematic longitudinal cross-sectional view of an aerosol-generating article for use with an aerosol-generating device comprising a heater element in accordance with the present invention;

FIG. 2 shows a schematic top view of a detail of a homogenised tobacco material for use in the rod of aerosol-generating substrate of an article in accordance with the invention; and

FIG. 3 shows a schematic longitudinal cross-sectional view of an aerosol-generating system comprising an electrically operated aerosol-generating device and the aerosol-generating article shown in FIG. 1.

The aerosol-generating article 10 shown in FIG. 1 comprises a rod of aerosol-generating substrate 12, a hollow cellulose acetate tube 14, a cooling element 16 and a mouthpiece filter 18. These four elements are arranged sequentially and in coaxial alignment and are circumscribed by a cigarette wrapper 20 to form the aerosol-generating article 10. The aerosol-generating article 10 has a mouth end 22, and a distal end 24 located at the opposite end of the article to the mouth end 22. The aerosol-generating article 10 shown in FIG. 1 is particularly suitable for use with an electrically operated aerosol-generating device comprising a heater for heating the rod of aerosol-generating substrate.

The rod of aerosol-generating substrate 12 has a length of approximately 12 millimetres and a diameter of approximately 7 millimetres. The rod 12 is cylindrical in shape and has a substantially circular cross-section.

The rod of aerosol-generating substrate 12 is formed from a sheet 26 of homogenised tobacco material, which is shown in detail in FIG. 2. In more detail, the rod of aerosol-generating substrate 12 comprises a gathered, crimped sheet 26 of homogenised tobacco material, which defines a plurality of channels extending longitudinally between the distal end 24 of the rod and a downstream end 22 of the rod 12.

As illustrated in FIG. 2, the sheet 26 of homogenised tobacco material comprises a plurality of formed fluid passageways 28 extending through a thickness of the sheet 26. The formed fluid passageways 28 are adapted to establish a fluid communication between two or more of the channels defined by the sheet 26 when in its gathered configuration. The formed fluid passageways 28 have a substantially circular cross-section and an equivalent diameter of about 250 micrometres. The sheet 26 comprises 25 formed fluid passageways per square centimetre.

FIG. 3 shows a portion of an electrically operated aerosol-generating system 200 that utilises a heater blade 210 to heat the rod of aerosol-generating substrate 12 of the aerosol-generating article 10 shown in FIG. 1. The heater blade 210 is mounted within an aerosol-generating article chamber within a housing of an electrically operated aerosol-generating device 212. The aerosol-generating device 212 defines a plurality of air holes 214 for allowing air to flow to the aerosol-generating article 10, as illustrated by the arrows in FIG. 3. The aerosol-generating device 212 comprises a power supply and electronics, which are not shown in FIG. 3.

The aerosol-generating article 10 shown in FIG. 1 is designed to engage with the aerosol-generating device 212 shown in FIG. 3 in order to be consumed. The aerosol-generating article 10 is inserted into the aerosol-generating device 212 so that the heater blade 210 is inserted into the rod of aerosol-generating substrate 12. The mouthpiece filter 18 projects outwards from the mouth end of the device 212. Once the aerosol-generating article 10 is engaged with the aerosol-generating device 212, a negative pressure may be applied to the mouth end 22 of the aerosol-generating article 10 and the rod of aerosol-generating substrate 12 is heated by the heater blade 210 to a temperature sufficient to generate an aerosol from the rod of aerosol-generating substrate 12. The aerosol is drawn through the mouth end filter 18.

It will be appreciated that the aerosol-generating article 10 shown in FIG. 1 may also be suitable for use with other types of aerosol-generating devices.

### EXAMPLES

Several examples of aerosol-generating substrates for use in an aerosol-generating article of the type illustrated in FIG. 1 and described above were prepared from sheets of homogenised tobacco material (cast leaf) having a thickness of about 200 micrometres. Some of their parameters are shown in Table 1 below.

| | | Formed fluid | Airflow | |
|---|---|---|---|---|
| | | passageway | arrangement | Airflow |
| | Formed fluid | cross- | density | arrangement |
| | passageway | sectional | [formed | surface |
| | equivalent | area | fluid passage- | area |
| | diameter | [square | ways/square | fraction |
| | [micrometres] | micrometres] | cm] | [%] |
| Example 1 | 100 | 7854 | 25 | 0.20 |
| Example 2 | 100 | 7854 | 50 | 0.40 |
| Example 3 | 125 | 12272 | 25 | 0.31 |
| Example 4 | 125 | 12272 | 36 | 0.44 |
| Example 5 | 250 | 49087 | 25 | 1.23 |
| Example 6 | 250 | 49087 | 36 | 1.77 |
| Example 7 | 500 | 196349 | 25 | 4.9 |
| Example 8 | 500 | 196349 | 50 | 5.8 |

The equivalent diameter of the formed fluid passageways and the number of formed fluid passageways per unit of sheet surface area were varied to explore different values of airflow arrangement surface area fraction—that is, the ratio between the cumulative cross-sectional area of the formed fluid passageways and the overall surface area of the sheet.

1.-15. (canceled)

16. An aerosol-generating article for producing an inhalable aerosol upon heating, the aerosol-generating article comprising:
a rod of aerosol-generating substrate, the rod comprising a sheet of homogenised plant material, the homogenised plant material being arranged longitudinally between an upstream end of the rod and a downstream end of the rod; and
a wrapper circumscribing the homogenised plant material,
wherein the sheet of homogenised plant material comprises a plurality of formed fluid passageways extending through a thickness of the sheet and configured to establish a fluid communication between opposite sides of the sheet.

17. The aerosol-generating article according to claim 16, further comprising a heating element provided as a susceptor embedded within the rod of aerosol-generating substrate.

18. The aerosol-generating article according to claim 16, wherein the sheet of homogenised plant material comprises at least about 20 formed fluid passageways per square centimetre.

19. The aerosol-generating article according to claim 16, wherein an average equivalent diameter of the formed fluid passageways is at least about 100 micrometres.

20. The aerosol-generating article according to claim 19, wherein the average equivalent diameter of the formed fluid passageways is at least about 200 micrometres.

21. The aerosol-generating article according to claim 16, wherein a cumulative surface area of the formed fluid passageways in the sheet of homogenised plant material represents at least about 0.1 percent of a surface area of the sheet of homogenised plant material.

22. The aerosol-generating article according to claim 16, wherein the formed fluid passageways are provided in a repeating pattern.

23. The aerosol-generating article according to claim 22, wherein the repeating pattern comprises a plurality of spaced apart rows of formed fluid passageways.

24. The aerosol-generating article according to claim 23, wherein a linear distance between adjacent formed fluid passageways in a row of formed fluid passageways is at least about 1 millimetre.

25. The aerosol-generating article according to claim 16, wherein a thickness of the sheet is between 25 micrometres and 500 micrometres.

26. The aerosol-generating article according to claim 16, wherein the sheet is crimped.

27. The aerosol-generating article according to claim 26, wherein the formed fluid passageways are formed in a non-crimped portion of the sheet.

28. A method of making a rod for an aerosol-generating substrate in an aerosol-generating article, the method comprising the steps of:
providing a sheet of homogenised plant material;
forming fluid passageways in the sheet of homogenised plant material, extending through a thickness of the sheet of homogenised plant material;
circumscribing the homogenised plant material with a wrapper to form a continuous rod, the homogenised plant material being arranged within the wrapper longitudinally between an upstream end of the rod and a downstream end of the rod, the plurality of formed fluid passageways establishing a fluid communication between opposite sides of the sheet of homogenised plant material; and
severing the continuous rod into a plurality of discrete rods.

29. A rod for an aerosol-generating substrate in an aerosol-generating article, the rod comprising:
a sheet of homogenised plant material, the homogenised plant material being arranged within the rod longitudinally between an upstream end of the rod and a downstream end of the rod; and
a wrapper circumscribing the homogenised plant material,
wherein the sheet of homogenised plant material comprises a plurality of formed fluid passageways extending through a thickness of the sheet of homogenised plant material and configured to establish a fluid communication between opposite sides of the sheet of homogenised plant material.

30. An aerosol-generating system, comprising:
an aerosol-generating article according to claim 17; and
an aerosol-generating device comprising a cavity configured to receive the aerosol-generating article and an induction source heater configured to produce an alternating electromagnetic field configured to induce a heat generating eddy current in a susceptor material of the susceptor.
